(19) United States
(12) Patent Application Publication
(10) Pub. No.: US 2012/0153630 A1
(43) Pub. Date: Jun. 21, 2012

(54) WIND ASSIST RARE EARTH MAGNET DRIVEN TURBINE

(76) Inventor: Michael Rogler Kildevaeld, Yarmouthport, MA (US)

(21) Appl. No.: 13/323,726

(22) Filed: Dec. 12, 2011

Related U.S. Application Data
(60) Provisional application No. 61/422,138, filed on Dec. 11, 2010.

(51) Int. Cl. H02K 21/00; F03D 9/02; H02N 11/00

(52) U.S. Cl. 290/55; 310/152; 74/DIG. 9

(57) ABSTRACT

In embodiments of the present invention improved capabilities are described for a turbine system that combines capturing airflow via turbine blades to turn a shaft with rare earth magnet drive of the shaft. The rare earth magnetics are disposed in two rings to generate rotational energy that turns the shaft.

### CROSS-REFERENCE TO RELATED APPLICATIONS

This application claims the benefit of the following provisional applications, each of which is hereby incorporated by reference in its entirety:

U.S. Ser. No. 61/422,138 filed Dec. 11, 2010.

### BACKGROUND OF THE INVENTION

### Field

This application relates to the field of producing electricity from renewable energy sources. In particular, this application relates to producing electricity via a turbine that is driven by rare earth magnets assisted by wind.

### SUMMARY OF THE INVENTION

Producing green energy with the use of Rare Earth Magnets to drive a rotating shaft with assistance of wind to overcome potential lock up areas in-between may find application in electricity generators and all forms of vehicle-based transportation. Examples include automobiles, trains, boats, planes, submarines, and others. In addition to producing electricity, such a system may also be an engine by itself for rotating wheels, wind propellers, water propellers, and other similar direct propulsion systems. It may alternative be used to charge batteries such as for providing power to electric motor(s) and other.

These and other systems, methods, objects, features, and advantages of the present invention will be apparent to those skilled in the art from the following detailed description of the preferred embodiment and the drawings. All documents mentioned herein are hereby incorporated in their entirety by reference.

### BRIEF DESCRIPTION OF THE FIGURES

The invention and the following detailed description of certain embodiments thereof may be understood by reference to the following figures:

FIG. 1 depicts a wind assisted, rare earth magnetic turbine generator.

FIG. 2 depicts a perspective view of an embodiment of the wind assisted, rare earth magnetic turbine generator.

FIG. 3 depicts a rear perspective view of the turbine generator.

FIG. 4 depicts a side view with a transparent outer housing.

FIG. 5 depicts a side view of the inner housing.

FIG. 6 depicts a side view with a transparent inner housing.

FIG. 7 depicts an exploded side view of the turbine.

FIG. 8 depicts an exploded view of an interior portion of the turbine.

FIG. 9 depicts a representative magnetic drive system.

FIG. 10 depicts front perspective view of a vehicle-based embodiment of the turbine.

FIG. 11 depicts bottom perspective view of a vehicle-based embodiment of the turbine.

FIG. 12 depicts a rear perspective view of a vehicle-based embodiment of the turbine.

FIG. 13 depicts a top perspective view of a vehicle-based embodiment of the turbine.

FIG. 14 depicts an alternate top perspective view of a vehicle-based embodiment of the turbine.

FIG. 15 depicts a bottom-side perspective view of a vehicle-based embodiment of the turbine.

### DETAILED DESCRIPTION OF THE PREFERRED EMBODIMENT(S)

A wind assist, rare earth magnetic turbine may be used with any type of green energy consumption system, such as but not limited to transportation and stationary electricity generation wind turbines. The wind assist, rare earth magnetic turbine may be retrofit to systems in use today, such as a windmill both for home use. Alternately it can be used in an wind driven electrical generation system for community use. Also it can be used with mega structure sized windmills sitting in the ocean or other areas to provide energy to the masses.

The preferred embodiment described herein of this wind assist, rare earth magnetic turbine is as a generator for a transportation device; however, the wind assist, rare earth magnetic turbine is an energy producer for anything that needs energy (e.g. electrical or rotational) to operate.

Wind is a typical by product of transportation so we will use this wind to our advantage. Issues with the use of wind, such as the speed of wind in transportation traveling between 20-300 MPH or greater are overcome herein with gearing, such as an automatic gearing system found in the automotive industry, to achieve a consistent speed of rotation to a drive axle or an electricity generator. This gearing will facilitate reducing high speed rotation of wind driven turbine blades to a lower shaft speed to create more torque to produce much more energy than a slow turning windmill turbine. Also the typical blades of a wind turbine or windmill which are very long in relation to the body size—as much as 100 feet on an ocean deployed mega windmill are not readily suited for use in transportation. The wind assist, rare earth magnetic turbine generator overcomes this challenge by using opposing rare earth magnets to maintain rotation of a drive axle or electricity generating shaft. Therefore, turbine blades in embodiment of the wind assist, rare earth magnetic turbine can be sized for use with a vehicle.

The magnets of the wind assist, rare earth magnetic turbine may be rare earth magnetics such as but not limited to Neodymium, which can maintain magnetism for 10,000 years or more. Such rare earth magnets can be disposed in in the wind assist, rare earth magnetic turbine to work with each other as a push drive, pull drive or mixture thereof to achieve rotational power when mounted into a rotary type system. Disposing the magnets so that the magnetic flux of the magnets opposes each other may provide push drive. Disposing the magnets to attract each other may provide pull drive. Disposing the magnets for a combination of attracting and opposing may provide mixed drive. An example of mixed drive may include fifty rare earth magnets disposed to a drive axle or shaft and fifty disposed on an outside housing. By changing the polar orientation of one or more of the magnets may help to overcome any potential lock up of the magnets. This may enable continual rotation with little or only occasional wind assist. Such a mixed arrangement may enable operation of the wind assist, rare earth magnetic turbine under calm conditions.

Once started rotating, the wind assist, rare earth magnetic turbine can generate power with or without continued use of wind. For example in a parked automobile the turbine could generate energy to a battery source. This system could charge batteries or could be used directly to power to one or more electric motors to produce travel. The wind assist, rare earth magnetic turbine could be mounted in the front of an automobile to take advantage of the wind produced from traveling with the use of batteries. The vehicle travel would produce more than enough wind required to generate rotational motion through the turbine blades. Once started, air flow into the blades could be controlled to improve aerodynamics which in turn improves vehicle operating efficiency all due to the rare earth magnets providing any of push drive, pull drive, or mixed drive to generate electricity to charge the vehicle batteries. The rare earth magnets are used in the turbine to help produce rotational force and therefore to produce energy independent of whether a vehicle is parked or traveling.

The wind assist, rare earth magnetic turbine may be further assisted by an alternative source of power such as solar panels that may help to ensure rotation of the magnetic system to avoid inter-magnet lock up. Also, a small amount of power produced by the turbine may be put back into the system to overcome potential magnetic lockup. The power from the alternate source or the feedback power may be applied to a small electric motor that provides a small amount rotational force to the turbine shaft or drive axle.

The wind used for assisting the wind assist, rare earth magnetic turbine may or may not need to flow through the vehicle as the turbine blades may be positioned to capture wind flowing around a moving vehicle. In the case of the wind traveling throughout the vehicle, a plenum system may be used channel the wind through the vehicle and past the turbine blades. Multiple turbines may be placed in the air flow path (e.g. front wheel/axle-based turbines, rear wheel/axle-based turbines).

Alternatively, the wheels of the vehicle could be shaped like wind capturing cups on the outside of vehicle to capture wind to help rotate the wheels in the forward direction.

The wind assist, rare earth magnetic turbine generator may also be configured with a motor to link to the wheels such as through linkage joints to power the wheels.

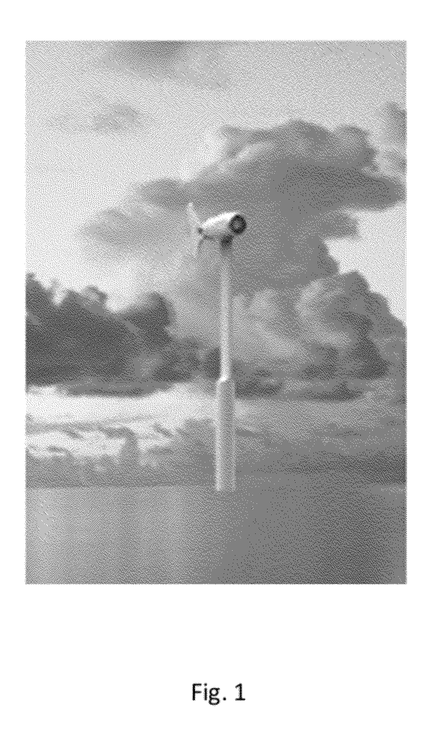

Referring to FIG. 1, the wind assist, rare earth magnetic turbine is depicted in a typical ocean-based environment. Unlike conventional ocean-based wind driven turbine generators, the wind assist, rare earth magnetic turbine has a small inlet and can be shaped similarly to a jet engine. The smaller size has a significant impact on the appearance 24, such turbines and therefore may mitigate many environmental concerns about deploying large windmill type farms in protected seas.

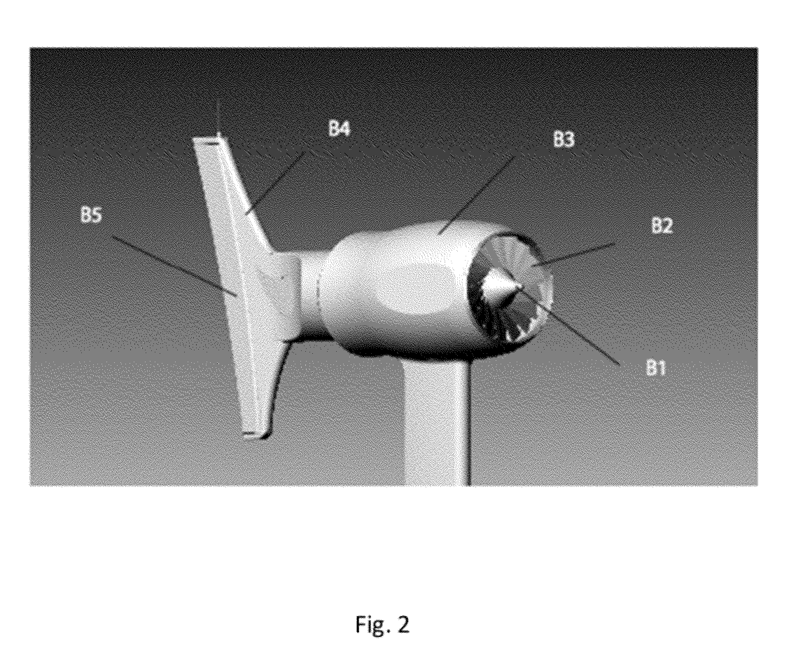

Referring to FIG. 2, a perspective view of an embodiment of the wind assisted, rare earth magnetic drive turbine, various elements are presented. A nose cone B1 may direct wind to turbine blades B2 which capture wind and cause a directional rotation of a center axle or shaft that may be used to generate electricity or other form of power. Outer body B3 may help in guiding wind through the turbine. Tail piece B4 may facilitate directing the turbine into the wind. Optionally rudder B5 may be controlled by a system that sensing wind direction proximal to the nose cone B1 to further adjust the position of the turbine relative to the wind direction for increased efficiency.

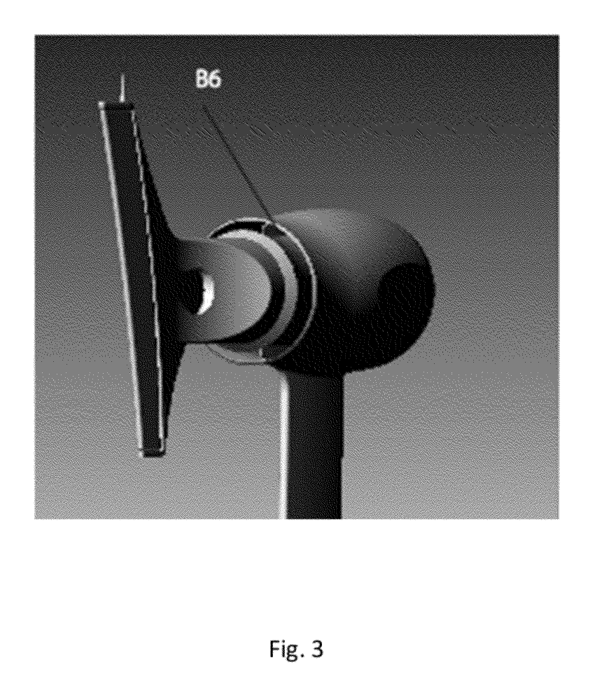

Referring to FIG. 3, which depicts a rear perspective view of the turbine depicts an exhaust port B6 for directing air out of the turbine housing toward the tail B4 and rudder B5.

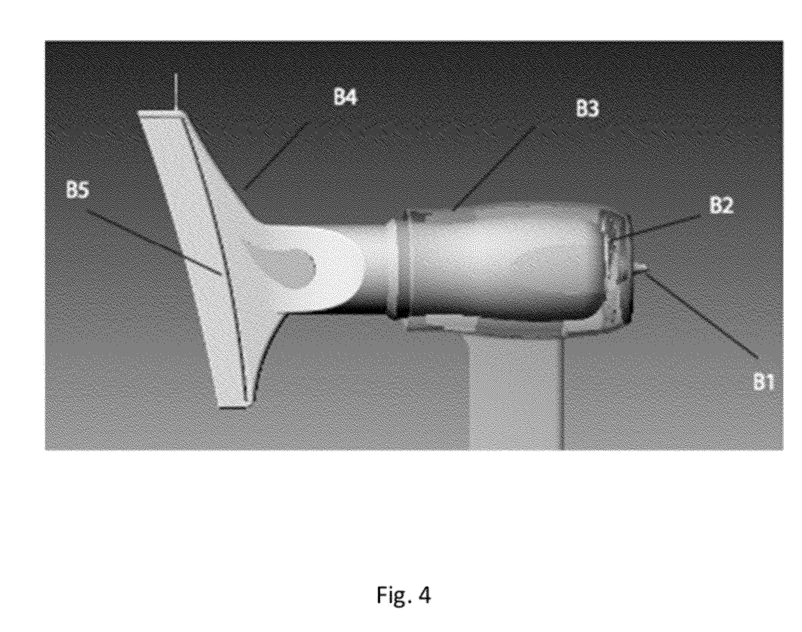

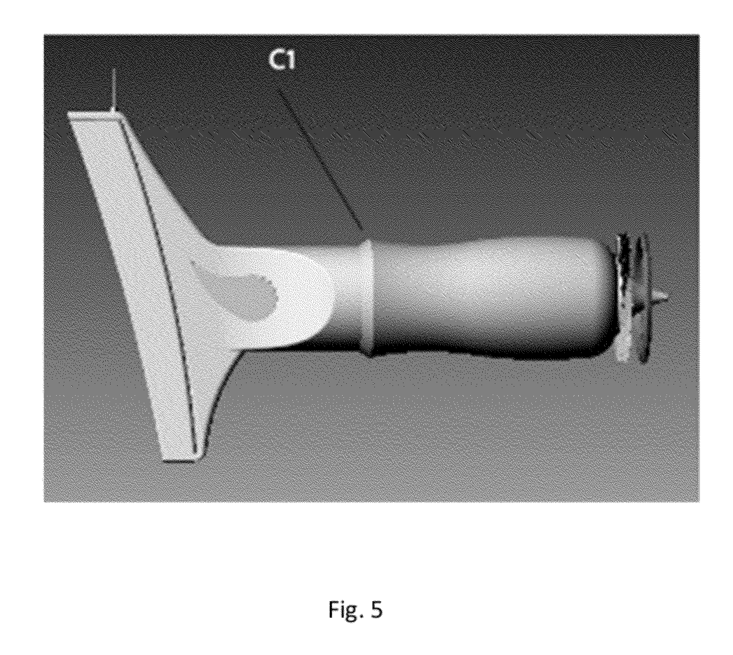

Referring to FIG. 4, which depicts a side view of the turbine, an inner housing is viewed through a transparent representation of the outer body B3. The inner housing may be shaped to assist wind guidance through the turbine by working cooperatively with outer body B3. FIG. 5 shows the inner housing C1 shape.

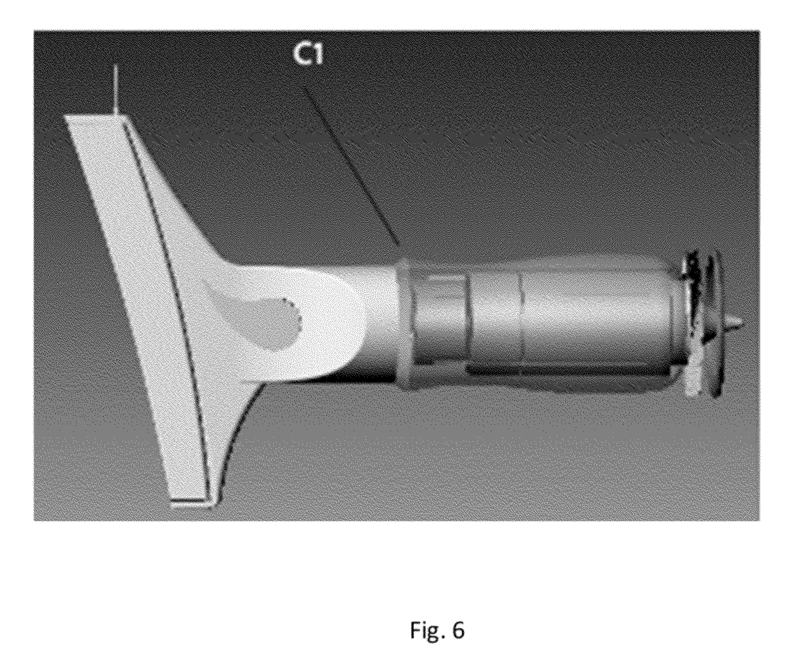

Referring to FIG. 6, which depicts a side view of the turbine, reveals a magnet and drive component enclosure within the inner housing C1.

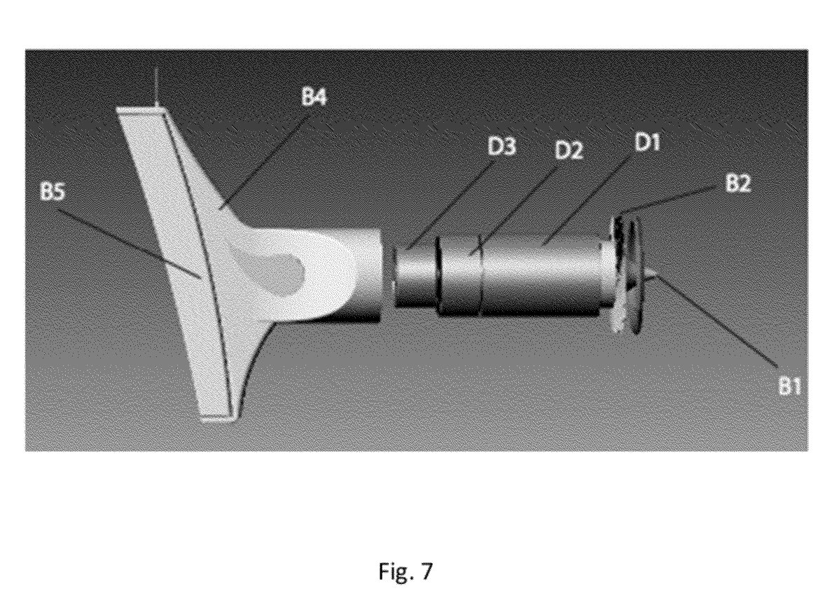

Referring to FIG. 7, which depicts an exploded view of the magnet and drive component enclosure, various portions of the turbine are presented. Magnet enclosure D1 may be disposed just behind the turbine blades B2. An optional gearing system D2 may be housed in-line with the magnet enclosure Dl. A generator system D3 may be disposed in-line after the gearing system D2 just ahead of the tail B4.

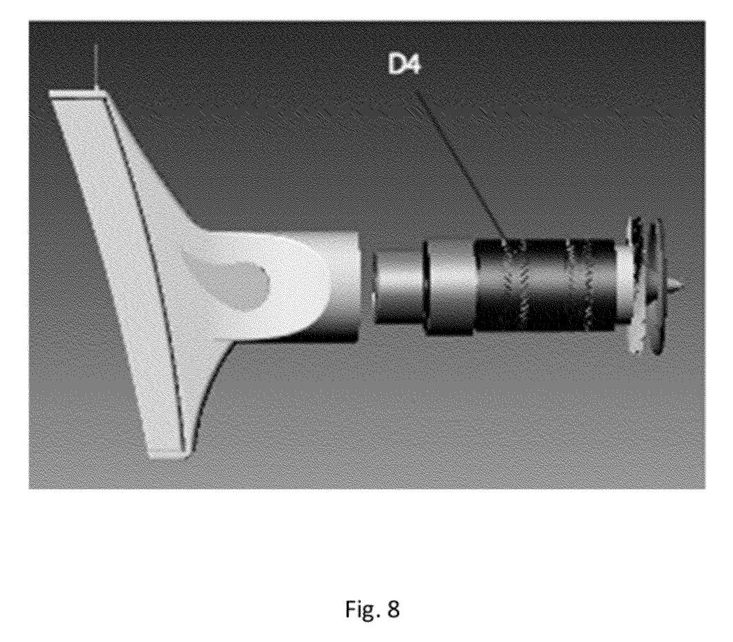

Referring to FIG. 8, which depicts details of the magnet system enclosure D1. In particular it depicts an outer ring of magnets, such as neodymium magnets. The position and number of magnets may be adjusted based on desired power generation, minimum wind assist requirement, overall weight, size, and the like.

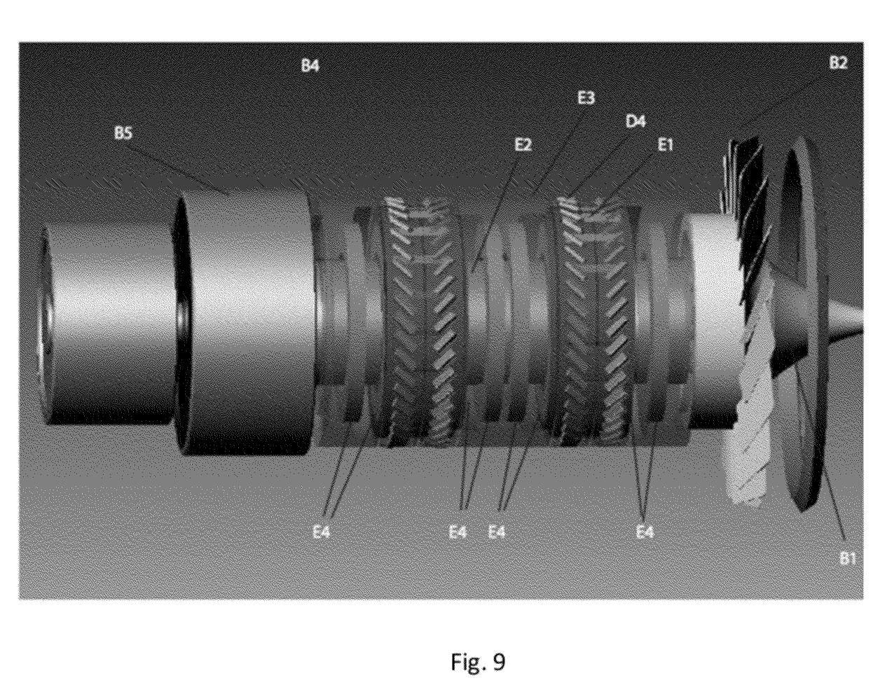

FIG. 9 depicts a representative magnet drive system. Inner rare earth magnets E1 may be mounted relative to the outer magnets D4 so as to enable the aforementioned pull drive and/or push drive of the optional gearing system D2 and the generation system D3. In the embodiment of FIG. 9, the inner magnets E1 may be substantially aligned with the drive axle or shaft E2. The center axle or shaft E2 may be driven by wind through blades B2 and/or through the magnetic drive provided by inner magnets E1 and outer magnets D4. Outer magnets D4 may be disposed at various angles relative to each other and non-aligned with inner magnets E1 so as to avoid lockup. As described herein above, the position, orientation, and magnetism of the magnets may be varied to achieve a desired degree of power, lock up prevention, and the like. In the embodiment of FIG. 9, outer magnet body E3 holds the outer magnets D4 fixed so that the inner magnets E1 may move relative to the outer magnets D4.

Rear earth magnet rings E4 may be disposed between the shaft and the outer magnet body E3 so as to act as a magnetic bearing, such as through magnetic levitation of the outer magnetic body E3 relative to the shaft. Alternatively, mechanical bearings may be used.

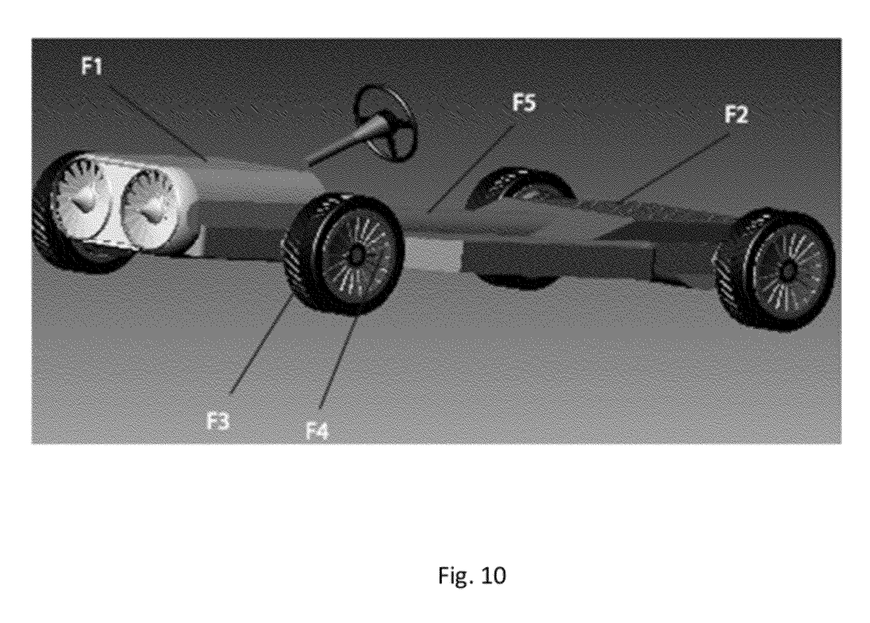

Referring to FIG. 10, which depicts a front perspective view of a vehicle-based embodiment of a wind assist, rare earth magnetic drive turbine, various aspects of the embodiment are shown. A dual configuration turbine F1 is shown positioned at a front of a vehicle to facilitate capturing wind as the vehicle moves forward. Electric motor batteries F2 may be charged by the dual turbine F1. The vehicle may include conventional tires F3 mounted on conventional wheels F4. A wire plenum F5 may be disposed in the lower chassis of the vehicle to connect the turbine F1 to the batteries F2.

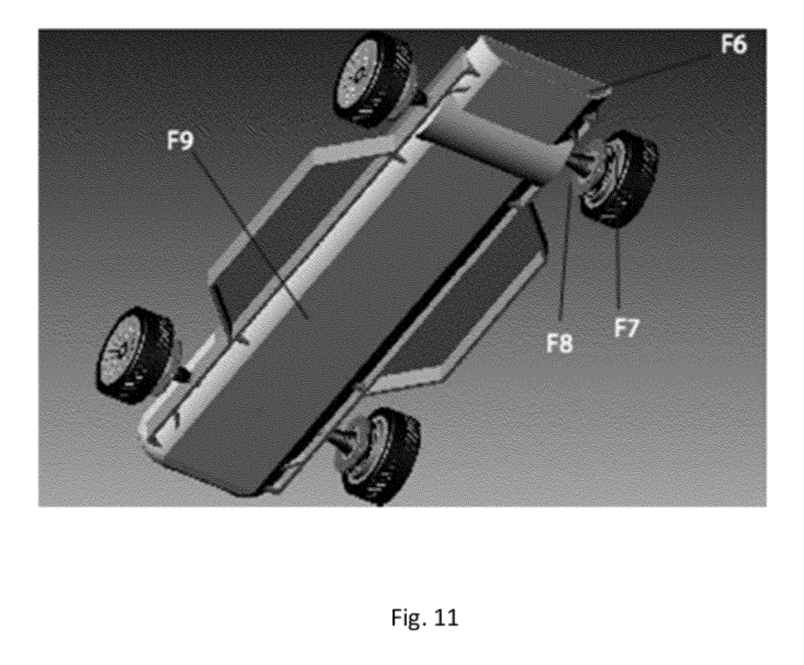

Referring to FIG. 11, which depicts a bottom perspective view of a vehicle-based embodiment of the turbine may include an air flow through plenum F9 for moving air from the turbines F1 out a rear air outlet port F6. Rather than having a central electric motor and mechanical power distribution system, the vehicle may have wheel-based electrical motors F7 disposed at one or more of the wheels, thereby allowing room in the vehicle for the turbines and air flow plenum. Braking energy from each disk brake F8 may be harvested for charging the batteries F2.

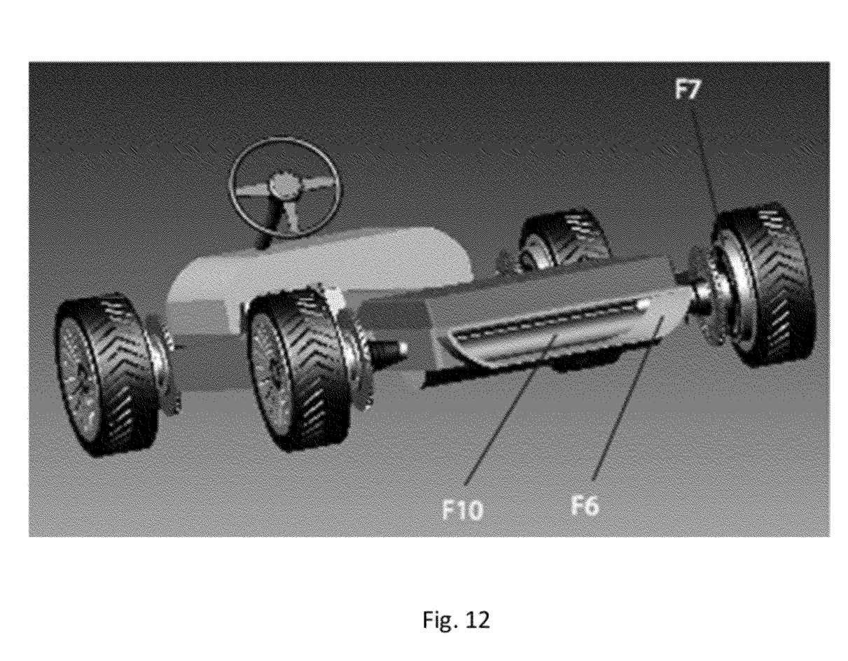

Referring to FIG. 12, which depicts a rear perspective view of the vehicle-based embodiment of the turbine, a rear axle turbine F10 may be disposed in the air flow plenum F9 so as to allow air flowing through the plenum to deliver power to the rear axle turbine F10.

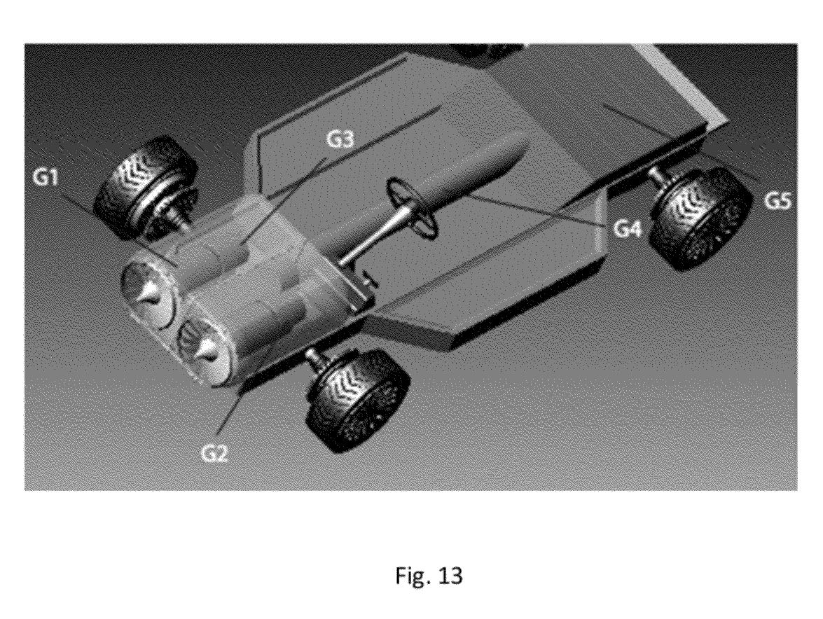

Referring to FIG. 13, which depicts an alternate top view of the vehicle-based embodiment of the turbine, elements of the turbine and electrical system are shown. Dual turbine F1 includes a magnet housing G1 followed by an optional gearing system G2 which is further followed in line with a drive shaft (not shown) by electricity generation system G3. Electricity from electricity generation system G3 is delivered to batteries G5 through electrical distribution channel G4.

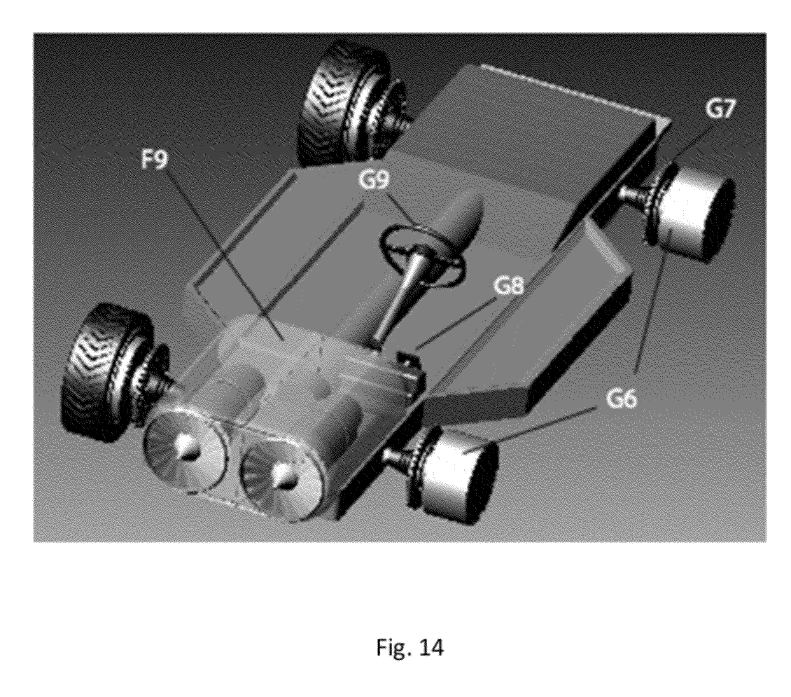

Referring to FIG. 14, which depicts further details of the vehicle mounted turbine and electrical power system, includes electric motor-embedded wheels G6, disk brakes G7, brake and go pedals G8, and steering wheel G9.

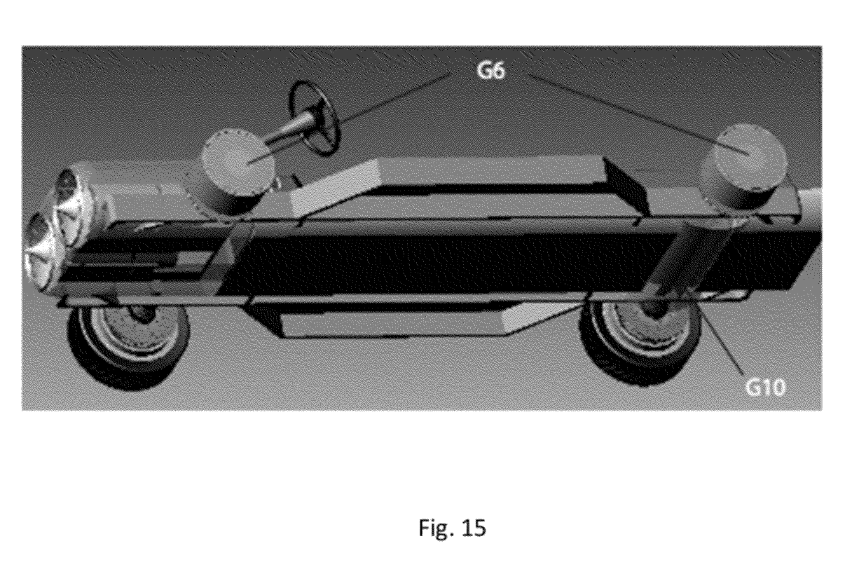

FIG. 15 shows an underside perspective view of the rear axle turbine system of FIG. 12.

1. A turbine, comprising:
a shaft;
a set of shaft-drive rare earth magnets disposed on an outer surface of the shaft;
a housing to rotatably hold the shaft;
a set of fixed rare earth magnets disposed in a ring around the set of shaft-drive magnets to facilitate magnetic drive of the shaft, wherein the fixed rare earth magnets are fixed relative to the housing; and
a set of turbine blades disposed at one end of the shaft for receiving air flow to rotate the shaft.

2. An electric vehicle drive system comprising:
an electrical generation turbine comprising:
a shaft;
a set of shaft-drive rare earth magnets disposed on an outer surface of the shaft ;
a housing to rotatably hold the shaft;
a set of fixed rare earth magnets disposed in a ring around the set of shaft-drive magnets to facilitate magnetic drive of the shaft, wherein the fixed rare earth magnets are fixed relative to the housing; and
a set of turbine blades disposed at one end of the shaft for receiving air flow to rotate the shaft;
an electrical generator disposed to receive the shaft and generate electricity when the shaft rotates;
a set of batteries for powering the vehicle and for receiving electricity from the electrical generator for maintaining an electrical charge in the batteries; and
one or more wheel-based electrical motors for propelling the vehicle.

3. An axle-based turbine propulsion system for a vehicle comprising:
a drive axle mounted between two wheels;
a set of axle-drive rare earth magnets disposed on an outer surface of the drive axle ;
a housing to rotatably hold the drive axle;
a set of fixed rare earth magnets disposed in a ring around the set of axle-drive magnets to facilitate magnetic drive of the drive axle, wherein the fixed rare earth magnets are fixed relative to the housing; and
a set of turbine blades disposed around the drive axle for receiving air flow to rotate the drive axle.
